(19) United States
(12) Patent Application Publication
(10) Pub. No.: US 2024/0213662 A1
(43) Pub. Date: Jun. 27, 2024

(54) DOCKING SYSTEM FOR USE WITH VEHICLES

(71) Applicant: AIRGAIN, Inc., San Diego, CA (US)

(72) Inventors: Cheng-Yuan Chin, San Diego, CA (US); Joe Romack, Scottsdale, AZ (US); Ali Sadri, San Diego, CA (US); Patrick Hibbs, Scottsdale, AZ (US); Brian Goodyear, San Diego, CA (US)

(21) Appl. No.: 18/529,052

(22) Filed: Dec. 5, 2023

Related U.S. Application Data
(60) Provisional application No. 63/435,474, filed on Dec. 27, 2022.

(51) Int. Cl. H01Q 1/32; H01Q 1/02; H01Q 1/12; H01Q 21/28

(52) U.S. Cl. CPC H01Q 1/3275; H01Q 1/02; H01Q 1/1207; H01Q 21/28

(57) ABSTRACT

A system for a vehicle comprises a dock and a housing configured to detachably connect to the dock. The dock comprises a base configured for attachment to a roof of the vehicle. The base comprises a recess and a conduit for accessing an interior of the vehicle. A first connector interface of the dock comprises a plurality of first electrical connectors configured to couple to respective electrical conductors arranged to pass through the conduit and into an interior of the vehicle. The housing is configured to detachably connect to the dock and dimensioned to be received by the recess of the base. The housing comprises a first electronics module coupled to one or more first antennas, and a second connector interface comprising a plurality of second electrical connectors configured to detachably connect to the first electrical connectors.

### CROSS-REFERENCE TO RELATED APPLICATION

This application claims the benefit of U.S. Provisional Patent Application No. 63/435,474, filed Dec. 27, 2022, which is incorporated herein by reference in its entirety.

### SUMMARY

One embodiment is directed to a system for a vehicle comprising a dock and a housing configured to detachably connect to the dock. The dock comprises a base configured for attachment to a roof of the vehicle. The base comprises a recess and a conduit for accessing an interior of the vehicle. A first connector interface of the dock comprises a plurality of first electrical connectors configured to couple to respective electrical conductors arranged to pass through the conduit and into an interior of the vehicle. The housing is configured to detachably connect to the dock and dimensioned to be received by the recess of the base. The housing comprises a first electronics module coupled to one or more first antennas, and a second connector interface comprising a plurality of second electrical connectors configured to detachably connect to the first electrical connectors.

Another embodiment is directed to a system for a vehicle comprising a dock and a housing configured to detachably connect to the dock. The dock comprises a base configured for attachment to a roof of the vehicle. The base comprises a recess and a conduit for accessing an interior of the vehicle. A first connector interface of the dock comprises a plurality of first electrical connectors configured to couple to respective electrical conductors arranged to pass through the conduit and into the interior of the vehicle. The housing is configured to detachably connect to the dock and dimensioned to be received by the recess of the base. The housing comprises a first electronics module coupled to one or more first antennas, and a second connector interface comprising a plurality of second electrical connectors configured to detachably connect to the first electrical connectors. A second module interface is supported by the base and configured to receive and electrically couple to a second additional module via a coupling arrangement passing through the roof. The second additional module is situated in the interior of the vehicle and comprises a second electronics module and one or more second antennas.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 illustrates a docking system for use with a vehicle in accordance with various embodiments;

FIG. 2 shows details of a dock of the docking system shown in FIG. 1;

FIG. 3 shows details of a removable housing of the docking system shown in FIG. 1;

FIG. 4 shows details of the dock of the docking system shown in FIG. 1;

FIG. 5 shows details of the removable housing of the docking system shown in FIG. 1;

FIG. 6 shows details of the dock and removable housing of the docking system shown in FIG. 1;

FIG. 7 illustrates a view of a docking system for use with a vehicle in accordance with various embodiments;

FIG. 8 illustrates another view of the docking system shown in FIG. 7;

FIG. 9 illustrates a view of a removable housing of the docking system shown in FIG. 7;

FIG. 10 illustrates a view of a dock of the docking system shown in FIG. 7;

FIG. 11 illustrates an exploded view of the docking system shown in FIG. 7;

FIG. 12 illustrates a docking system in accordance with various embodiments;

FIG. 13 illustrates a docking system in accordance with various embodiments;

FIG. 14 illustrates a docking system in accordance with various embodiments; and

FIG. 15 illustrates a docking system in accordance with various embodiments.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments of the disclosure are directed to docking system for use with vehicles. A docking system of the present disclosure includes a dock comprising a base which can be affixed to a surface of a vehicle and a housing configured to detachably connect to the dock. For example, the base can be affixed to a roof of a vehicle, and the housing can be attached to, and detached from, the base as needed or desired. The housing is configured to support an electronics module coupled to one or more antennas. The one or more antennas can include one or more cellular (e.g., 4G, 5G, 6G, FR1, FR2), Wi-Fi®, GPS, and/or satellite communication antennas. In some embodiments, the docking system can include one or more sensors. The one or more sensors can include one or more of an accelerometer, a gyroscope, a temperature sensor, a camera, a radar sensor, and a lidar sensor.

A docking system of the present disclosure provides a number of advantages over conventional systems. A conventional rooftop electronics system is generally a unitary structure mounted to the roof of a vehicle, making it very difficult and expensive to repair and/or upgrade. For example, labor, time, and materials are required to remove a conventional electronics system from the roof of a vehicle and to install a repaired or upgraded replacement system. The replacement work can result in damage to the vehicle's roof, interior, and/or electrical connection arrangement.

Embodiments of the disclosure are defined in the claims. However, below there is provided a non-exhaustive listing of non-limiting examples. Any one or more of the features of these examples may be combined with any one or more features of another example, embodiment, or aspect described herein.

Example Ex1. A system for a vehicle comprises a dock comprising a base configured for attachment to a roof of the vehicle, the base comprising a recess and a conduit for accessing an interior of the vehicle. The dock comprises a first connector interface comprising a plurality of first electrical connectors configured to couple to respective electrical conductors arranged to pass through the conduit and into an interior of the vehicle. A housing is configured to detachably connect to the dock, the housing dimensioned to be received by the recess of the base and comprising a first electronics module coupled to one or more first antennas and a second connector interface comprising a plurality of second electrical connectors configured to detachably connect to the first electrical connectors.

Example Ex2. The system according to Ex1, comprising an attachment arrangement configured to slidably attach the housing to the dock.

Example Ex3. The system according to Ex1, comprising an attachment arrangement configured to rotatably attach the housing to the dock.

Example Ex4. The system according to Ex1, comprising an attachment arrangement configured to attach the housing to the dock, wherein the attachment arrangement comprises a cam lever disposed at a first wall of the base and configured to engage a cam interface situated at a rear surface of the housing, and a guide slot at a front surface of the housing opposing the rear surface, the guide slot configured to receive a lip extending from a second wall of the base opposing the first wall.

Example Ex5. The system according to Ex4, wherein actuation of the cam lever relative to the cam interface causes the guide slot to engage the lip of the base.

Example Ex6. The system according to Ex4, wherein the attachment arrangement comprises an eject spring disposed on the second wall of the base opposing the first wall. Example Ex7. The system according to one or more of Ex2 to Ex6, wherein the attachment arrangement is configured to cause the first connector interface to matingly engage the second connector interface.

Example Ex8. The system according to one or more of Ex1 to Ex7, wherein the first and second electrical connectors comprise power, data, and radio frequency (RF) connectors. Example Ex9. The system according to one or more of Ex1 to Ex8, wherein the base is configured to serve as a heatsink for the first electronics module of the housing.

Example Ex10. The system according to one or more of Ex1 to Ex9, wherein the housing comprises a heatsink.

Example Ex11. The system according to one or more of Ex1 to Ex10, wherein the base comprises a second module interface configured to receive and electrically couple to a second additional module via a coupling arrangement passing through the roof, and the second additional module is situated in the interior of the vehicle proximate the base and comprises a second electronics module and one or more second antennas.

Example Ex12. The system according to one or more of Ex1 to Ex11, wherein the housing comprises a third module interface configured to receive and electrically couple to a third additional module comprising a third electronics module and one or more third antennas.

Example Ex13. The system according to one or more of Ex1 to Ex12, wherein the base comprises a fourth electronics module coupled to one or more fourth antennas.

Example Ex14. The system according to one or more of Ex1 to Ex13, comprising one or more sensors.

Example Ex15. The system of Ex14, wherein the one or more sensors comprise one or more of an accelerometer, a gyroscope, a temperature sensor, a camera, a radar sensor, and a lidar sensor.

Example Ex16. The system according to one or more of Ex1 to Ex15, wherein in the one or more antennas comprise one or more cellular, Wi-Fi, GPS, and satellite communication antennas.

Example Ex17. A system for a vehicle comprises a dock comprising a base configured for attachment to a roof of the vehicle, the base comprising a recess and a conduit for accessing an interior of the vehicle. The dock comprises a first connector interface comprising a plurality of first electrical connectors configured to couple to respective electrical conductors arranged to pass through the conduit and into the interior of the vehicle.

A housing is configured to detachably connect to the dock, the housing dimensioned to be received by the recess of the base and comprising a first electronics module coupled to one or more first antennas and a second connector interface comprising a plurality of second electrical connectors configured to detachably connect to the first electrical connectors. A second module interface is supported by the base and configured to receive and electrically couple to a second additional module via a coupling arrangement passing through the roof, wherein the second additional module is situated in the interior of the vehicle and comprises a second electronics module and one or more second antennas.

Example Ex18. The system according to Ex17, wherein the coupling arrangement comprises a snap-on fastening arrangement.

Example Ex19. The system according to Ex17, comprising an attachment arrangement configured to slidably attach the housing to the dock.

Example Ex20. The system according to Ex17, comprising an attachment arrangement configured to rotatably attach the housing to the dock.

Example Ex21. The system according to Ex19 or Ex20, wherein the attachment arrangement is configured to cause the first connector interface to matingly engage the second connector interface.

Example Ex22. The system according to one or more of Ex17 to Ex21, wherein the first and second electrical connectors comprise power, data, and radio frequency (RF) connectors.

Example Ex23. The system according to one or more of Ex17 to Ex22, wherein the base is configured to serve as a heatsink for the first electronics module of the housing. Example Ex24. The system according to one or more of Ex17 to Ex23, wherein the housing comprises a heatsink.

Example Ex25. The system according to one or more of Ex17 to Ex24, wherein the housing comprises a third module interface configured to receive and electrically couple to a third additional module comprising a third electronics module and one or more third antennas.

Example Ex26. The system according to one or more of Ex17 to Ex25, wherein the base comprises a fourth electronics module coupled to one or more fourth antennas.

Example Ex27. The system according to one or more of Ex17 to Ex26, comprising one or more sensors.

Example Ex28. The system of Ex27, wherein the one or more sensors comprise one or more of an accelerometer, a gyroscope, a temperature sensor, a camera, a radar sensor, and a lidar sensor.

Example Ex29. The system according to one or more of Ex17 to Ex28, wherein in the one or more antennas comprise one or more cellular, Wi-Fi, GPS, and satellite communication antennas.

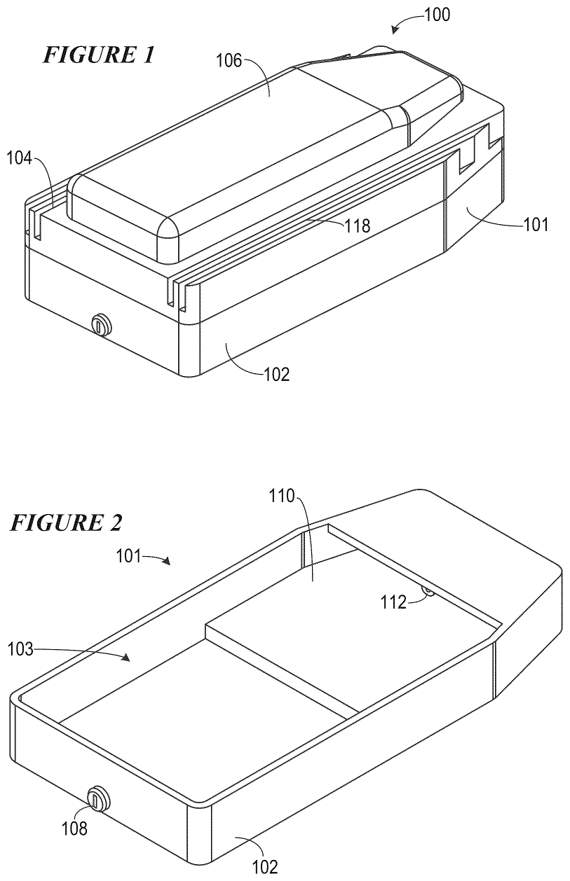

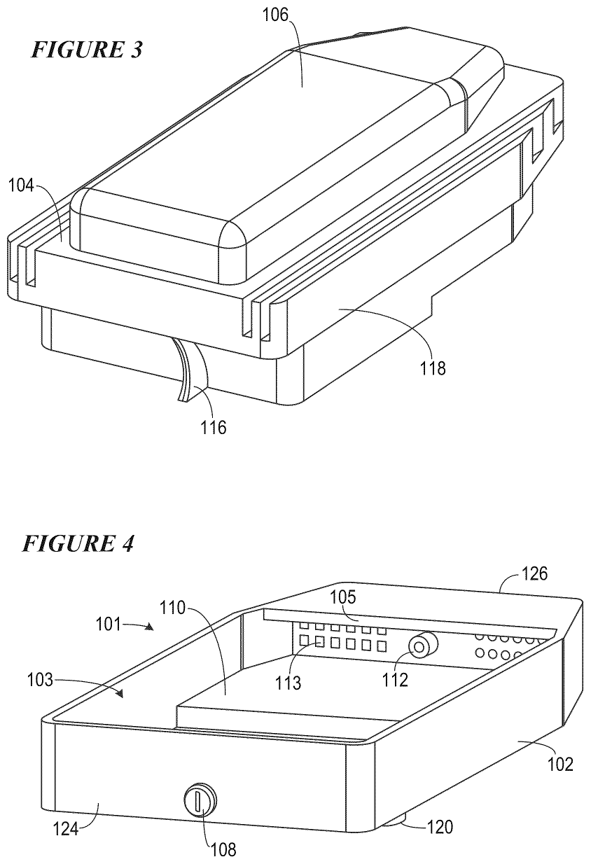

FIG. 1 illustrates a docking system 100 for use with a vehicle in accordance with various embodiments. The docking system 100 shown in FIG. 1 includes a dock 101 to which a removable housing 104 can be attached and detached. FIGS. 2-6 are different views showing details of the dock 101 and the removable housing 104 shown in FIG. 1. The dock 101 includes a base 102 configured for attachment to a roof or other surface of a vehicle. For example, the dock 101 can be configured for attachment to a roof of an automobile.

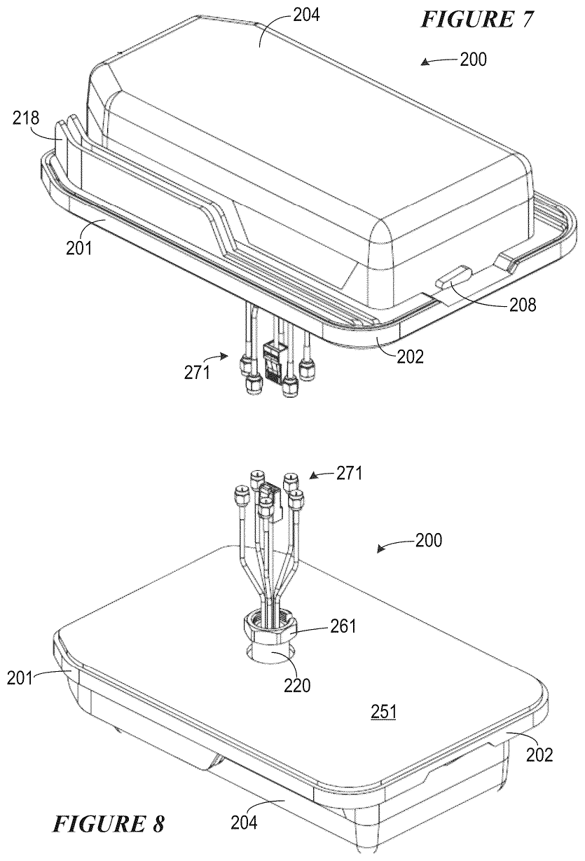

The base 102 includes a recess 103 configured to receive the housing 104. The base 102 also includes a conduit 120 (see FIG. 6) configured to provide access to an interior of the vehicle. For example, the conduit 120 can include a hollow member which extends from the base 102 and protrudes through a hole provided in the roof of the vehicle. The conduit 120 provides a pathway for cables to extend between the docking system 100 and electrical conductors disposed within the interior of the vehicle (e.g., for coupling to vehicle electronics). The dock 101 also includes a first connector interface 113 comprising a plurality of first electrical connectors configured to couple to respective electrical conductors (see FIGS. 7 and 8) arranged to pass through the conduit 120 and into the interior of the vehicle. The base 102 can include a cable tray 110 which provides space for containing the electrical conductors that pass through the conduit 120.

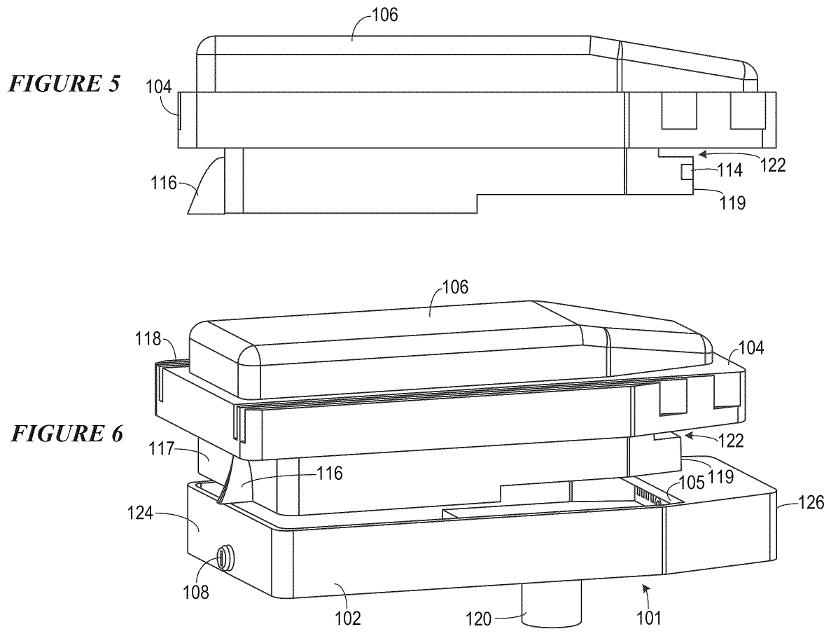

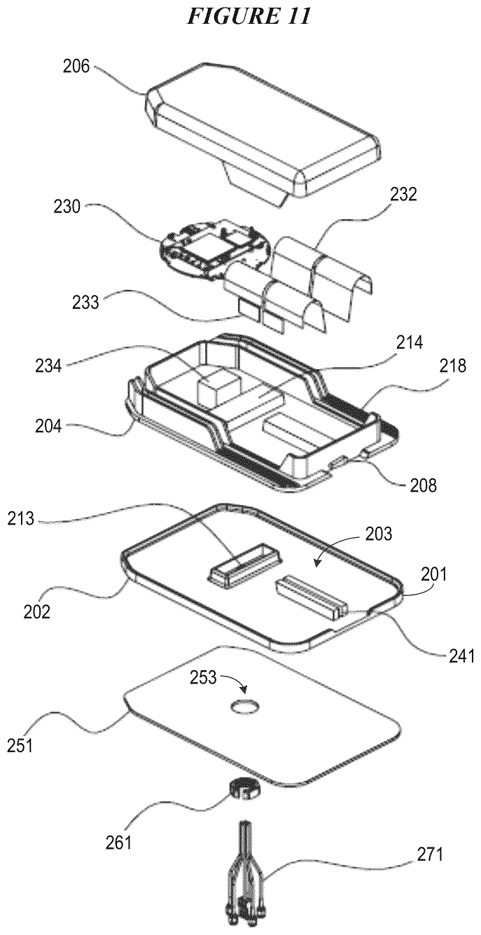

The housing 104 is configured to detachably connect to the dock 101 and is dimensioned to be received by the recess 103 of the base 102. The housing 104 can comprise a first electronics module coupled to one or more first antennas (see, e.g., FIG. 11). For example, the housing 104 can comprise a radome. The housing 104 also includes a second connector interface 114 (see FIGS. 5 and 11) comprising a plurality of second electrical connectors configured to detachably connect to the first electrical connectors of the first connector interface 113. Typically, the connector interfaces 113, 114 include power, data, and radio frequency (RF) connectors. The housing 104 can include a heatsink 118, such as in the form of heatsink fins extending along sides of the housing 104. Additionally, or alternatively, the base 102 can serve as a heatsink for the first electronics module disposed in the housing 104.

The docking system 100 can include an attachment arrangement configured to slidably or rotatably attach the housing 104 to the base 102. According to the embodiment shown in FIGS. 1-6, the housing 104 includes a guide slot 122 provided at a front surface 119 of the housing 104 (see FIGS. 5-6). The base 102 includes a lip 105 extending from a second wall 126 of the base 102. In some implementations, the attachment arrangement can include a cam lever 108 disposed at a first wall 124 of the base 102 and a cam interface 116 situated at a rear surface 117 of the housing 104. The cam lever 108 is actuated by turning the cam lever 108, such as in a clockwise direction (e.g., using a screwdriver).

The cam lever 108 is configured to engage the cam interface 116 after positioning the housing 104 within the recess 103 of the base 102. As previously discussed, the housing 104 includes a guide slot 122 provided at a front surface 119 of the housing 104. The base 102 includes a lip 105 extending from a second wall 126 of the base 102. The guide slot 122 is configured to receive the lip 105 in response to rotation of the cam lever 108 relative to the cam interface 116. Actuation of the cam lever 108 causes the housing 104 to lock into the recess 103 of the base 102. The front surface 119 of the housing 104 is locked into position by capture of the lip 105 within the guide slot 122. The rear surface 117 of the housing is locked into position by actuation of the cam lever 108 relative to the cam interface 116.

As the housing 104 moves toward the second wall 126 of the base 102 due to camming action between the cam lever 108 and the cam interface 116, the first connector interface 113 of the housing 104 matingly engages, and electrically couples with, the second connector interface 114 of the base 102. At the same time, the front surface 119 of the housing 104 engages, and compresses, an eject spring 112 disposed on the second wall 126 of the base 102. With the housing 104 locked into base 102, the eject spring remains under compression. In order to detach the housing 104 from the base 102, the cam lever 108 is actuated by turning the cam lever 108 in a counterclockwise direction. Under the force of the eject spring 112, the lip 105 of the base 102 disengages the guide slot of the housing 104 causing the connector interfaces 113, 114 to disconnect, and positioning the housing 104 within the base 102 for manual removal.

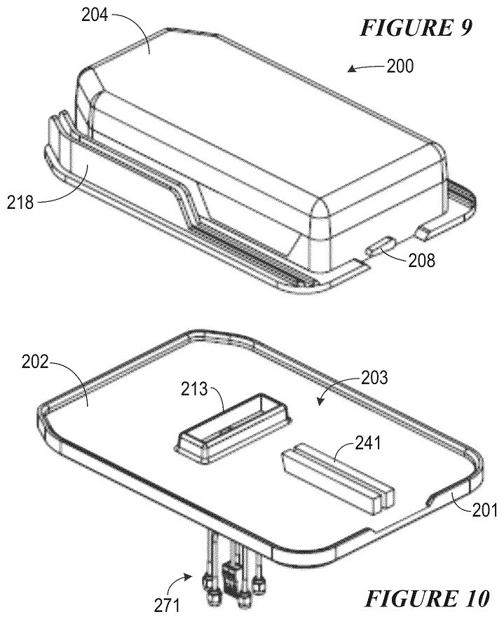

FIGS. 7 and 8 illustrates a docking system 200 for use with a vehicle in accordance with various embodiments. The docking system 200 includes a dock 201 to which a removable housing 204 can be attached and detached. FIGS. 9-11 are different views showing details of the dock 201 and the removable housing 204 shown in FIGS. 7 and 8. The dock 201 includes a base 202 configured for attachment to a roof or other surface of a vehicle. For example, the dock 201 can be configured to attach to a roof of an automobile via an adhesive pad 251.

As can be seen in FIGS. 7-11, the base 202 includes a recess 203 configured to receive the housing 204. The base 202 also includes a conduit 220 (see FIG. 8) configured to provide access to an interior of the vehicle. For example, the conduit 220 can include a hollow member which extends from the base 202 and protrudes through a hole provided in the roof of the vehicle. The conduit 220 also extends through a hole 253 provided in the adhesive pad 251 which adhesively affixes the dock 201 to the surface (e.g., roof) of the vehicle. The conduit 220 provides a pathway for cables 271 to extend between the docking system 200 and electrical conductors disposed within the interior of the vehicle (e.g., for coupling to vehicle electronics). The conduit 220 can be threaded and configured to receive a locknut 261 to facilitate installation.

The dock 201 also includes a first connector interface 213 disposed on the base 202 and comprising a plurality of first electrical connectors configured to couple to respective electrical conductors 271 arranged to pass through the conduit 220 and into the interior of the vehicle. The electrical conductors 271 include connectors configured to couple with connectors of corresponding conductors within the vehicle. The conductors 271 provide electrical coupling between the docking system 200 and the vehicle electronics.

The housing 204 is configured to detachably connect to the dock 201 and is dimensioned to be received by the recess 203 of the base 202. With reference to FIG. 11, the housing 204 is configured to house an electronics module 230 coupled to one or more antennas and to a second connector interface 214. The electronics module 230 can include a multilayer motherboard populated with a number of components including passive and active components, surface mounted components, power modules, one or more controllers and/or processors, connectors, and ports, among other components. The one or more antennas can include one or more cellular antennas 232 and/or one or more Wi-Fi® antennas 233. The one or more antennas can also include a GPS antenna and/or a satellite communications antenna. A radome 206 is disposed over (or can contain) the electronics module 230 and antennas 232, 233.

The second connector interface 214 of the housing 204 comprises a plurality of second electrical connectors configured to detachably connect to the first electrical connectors of the first connector interface 213 of the dock 201. Typically, the connector interfaces 213, 214 include power, data, and radio frequency (RF) connectors. The housing 204 can include a heatsink 234 which is thermally coupled to the electronics module 230. The housing 204 can also includes a heatsink 218, such as in the form of heatsink fins extending along sides of the housing 204. Additionally, or alternatively, the base 202 can serve as a heatsink for the electronics module 230 disposed in the housing 204.

The docking system 200 can include an attachment arrangement configured to slidably or rotatably attach the housing 204 to the base 202. According to the embodiment shown in FIGS. 7-11, the base 202 includes a retention latch 241 which mechanically engages and cooperates with a latching device 208 of the housing 204 to detachably connect the housing 204 to the base 202. FIG. 7 shows the latching device 208 in a latched orientation (e.g., a left/counterclockwise position) relative to the retention latch 241, which provides for secured affixation of the housing 204 to the base 202. Manually moving the latching device 208 to an unlatched orientation (e.g., a right/clockwise position) relative to the retention latch 241 provides for decoupling of the housing 204 from the base 202.

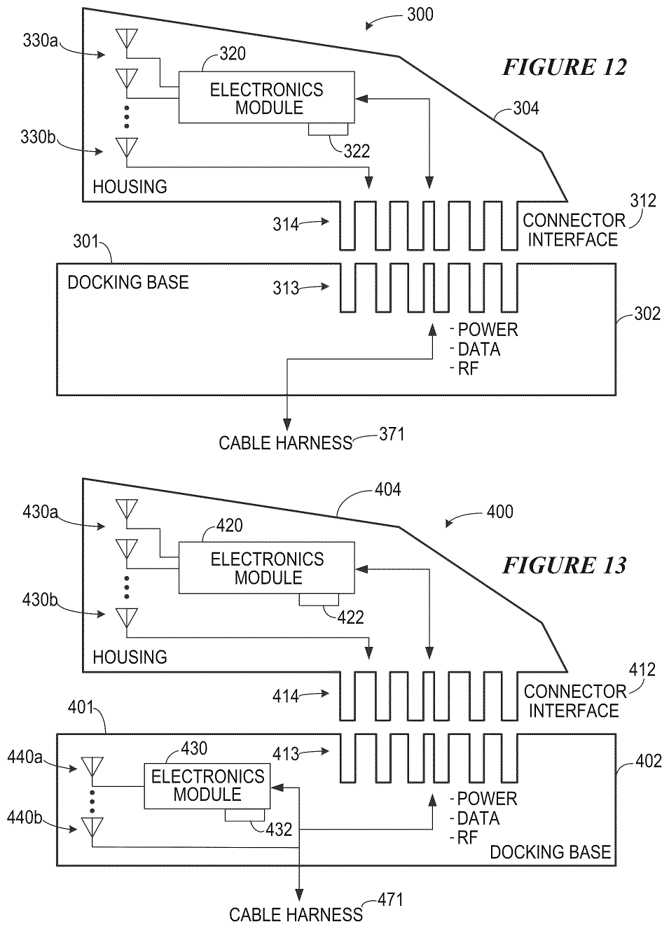

FIG. 12 illustrates a docking system in accordance with various embodiments. The docking system 300 shown in FIG. 12 includes a dock 301 which comprises a base 302 configured to be affixed to a surface (e.g., a roof) of a vehicle. The docking system 300 also includes a housing 304 which contains various electronics and components. The docking system 300 further includes a connector interface 312 which provides electrical coupling (e.g., power, data, RF) between the base 302 and the housing 304. The base 302 includes a first connector interface 313 and the housing 304 includes a second connector interface 314, the combination of which defines the connector interface 312.

The housing 304 contains an electronics module 320 coupled to one or more antennas 330a, such as one or more cellular, Wi-Fi®, GPS, and satellite communication antennas. The electronics module 320 can include a multilayer motherboard populated with a number of components including passive and active components, surface mounted components, power modules, one or more controllers and/or processors, connectors, and ports, among other components. The electronics module 320 is communicatively coupled to the second connector interface 314 of the housing 304. In some implementations, one or more antennas 330b can be coupled to the second connector interface 314 (e.g., rather than to the electronics module 320). The electronics module 320 and the one or more antennas 330b can be communicatively coupled to a cable harness 371 (see, e.g., FIG. 8) via the connector interface 312.

The electronics module 320 can include, or be coupled to, one or more sensors 322, such as one or more of an accelerometer, a gyroscope, a temperature sensor, a camera, a radar sensor, and a lidar sensor. Sensor data can be used to evaluate the operating condition of the docking system 300. For example, a temperature sensor can be used to monitor the operating temperature of key components (e.g., electronics module 320) of the docking system 300. An accelerometer or gyroscope can be used to monitor the physical forces acting on sensitive components of the docking system 300. Sensors such as a camera, radar, and lidar can provide meaningful data for assessing driver behavior and analyzing accidents.

Sensor data can be communicated to the cloud and/or to smartphones/tablets within or proximate the vehicle via the docking system 300.

FIG. 13 illustrates a docking system in accordance with various embodiments. The docking system 400 shown in FIG. 13 includes the structures and components of the docking system 300 shown in FIG. 12 and includes additional features. The docking system 400 includes a dock 401 which comprises a base 402 configured to be affixed to a surface (e.g., a roof) of a vehicle. The docking system 400 also includes a housing 404, which contains various electronics and components, and a connector interface 412, which provides electrical coupling (e.g., power, data, RF) between the base 402 and the housing 404. The base 402 includes a first connector interface 413 and the housing 404 includes a second connector interface 414, the combination of which defines the connector interface 412.

The housing 404 contains an electronics module 420 coupled to one or more antennas 430a, such as any of the antennas listed above. The electronics module 420 can include, or be coupled to, one or more sensors 422, such as any of the sensors listed above. The electronics module 420 can include a multilayer motherboard populated with a number of components including passive and active components, surface mounted components, power modules, one or more controllers and/or processors, connectors, and ports, among other components. The electronics module 420 is communicatively coupled to the second connector interface 414 of the housing 404. In some implementations, one or more antennas 430b can be coupled to the second connector interface 414. The electronics module 420 and the one or more antennas 430b can be communicatively coupled to a cable harness 471 via the connector interface 412.

In the embodiment shown in FIG. 13, the base 402 includes an additional electronics module 430. The electronics module 430 can include a multilayer motherboard populated with a number of components including passive and active components, surface mounted components, power modules, one or more controllers and/or processors, connectors, and ports, among other components. The electronics module 430 can be coupled to one or more antennas 440a, such as any of the antennas listed above. The electronics module 430 can include, or be coupled to, one or more sensors 432, such as any of the sensors listed above. The electronics module 430 is communicatively coupled to the cable harness 471. In some implementations, one or more antennas 440b of the base 402 can be coupled to the cable harness 417. In some implementations, the electronics module 430 of the base 402 can be communicatively coupled to the electronics module 420 of the housing 404 via the connector interface 412.

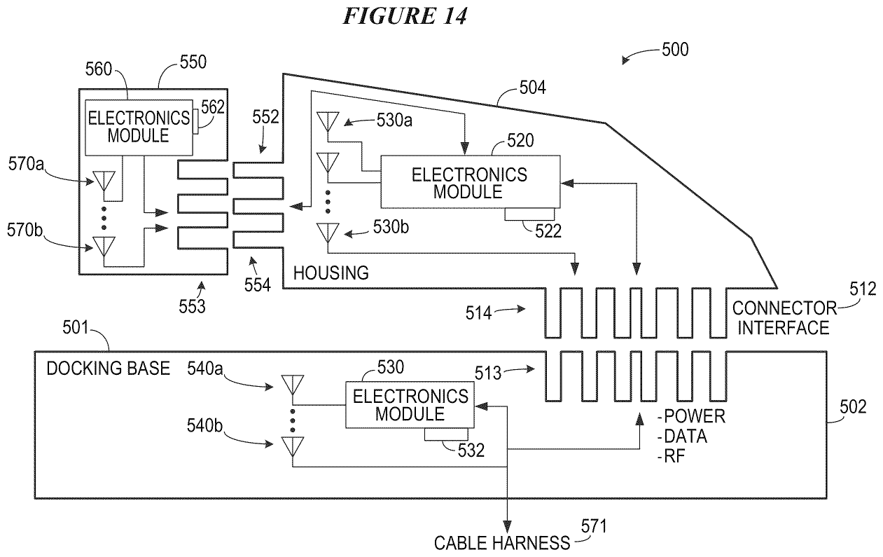

FIG. 14 illustrates a docking system in accordance with various embodiments. The docking system 500 shown in FIG. 14 includes the structures and components of the docking system 400 shown in FIG. 13 and includes additional features. The docking system 500 includes a dock 501 which comprises a base 502 configured to be affixed to a surface (e.g., a roof) of a vehicle. The docking system 500 also includes a housing 504, which contains various electronics and components, and a connector interface 512, which provides electrical coupling (e.g., power, data, RF) between the base 502 and the housing 504. The base 502 includes a first connector interface 513 and the housing 504 includes a second connector interface 514, the combination of which defines the connector interface 512.

The housing 504 contains an electronics module 520 coupled to one or more antennas 530a, such as any of the antennas listed above. The electronics module 520 can include, or be coupled to, one or more sensors 522, such as any of the sensors listed above. The electronics module 520 can include a multilayer motherboard populated with a number of components including passive and active components, surface mounted components, power modules, one or more controllers and/or processors, connectors, and ports, among other components. The electronics module 520 is communicatively coupled to the second connector interface 514 of the housing 504. In some implementations, one or more antennas 530b can be coupled to the second connector interface 514. The electronics module 520 and the one or more antennas 530b can be communicatively coupled to a cable harness 571 via the connector interface 512.

The base 502 includes an additional electronics module 530. The electronics module 530 can include a multilayer motherboard populated with a number of components including passive and active components, surface mounted components, power modules, one or more controllers and/or processors, connectors, and ports, among other components. The electronics module 530 can be coupled to one or more antennas 540a, such as any of the sensors listed above. The electronics module 530 can include, or be coupled to, one or more sensors 532, such as any of the sensors listed above. The electronics module 530 is communicatively coupled to the cable harness 571. In various implementations, one or more antennas 540b of the base 502 can be coupled to the cable harness 517. In some implementations, the electronics module 530 of the base 502 can be communicatively coupled to the electronics module 520 of the housing 504 via the connector interface 512.

The embodiment shown in FIG. 14 includes an additional module 550 configured to couple to the housing 504 and housing electronics 520 via a connector interface 552. The connector interface 552 comprises a third connector interface 553 of the additional module 550 and a fourth connector interface 554 of the housing 504. The third connector interface 553 comprises electrical connectors configured to detachably connect to corresponding electrical connectors of the fourth connector interface 554.

The additional module 550 includes an electronics module 560 which can be coupled to one or more antennas 570a, such as any of the antennas listed above. The electronics module 560 can include, or be coupled to, one or more sensors 562, such as any of the sensors listed above. The electronics module 560 can include a multilayer motherboard populated with a number of components including passive and active components, surface mounted components, power modules, one or more controllers and/or processors, connectors, and ports, among other components. The electronics module 560 is communicatively coupled to the housing electronics 520 via the connector interface 552. The additional module 550 can include one or more antennas 570b which can be coupled to the housing electronics 520 via the connector interface 552 or to the cable harness 571 via the connector interface 512. In some implementations, the electronics module 530 of the base 502 can be communicatively coupled to the electronics module 560 of the additional module 550 via the connector interfaces 512 and 552.

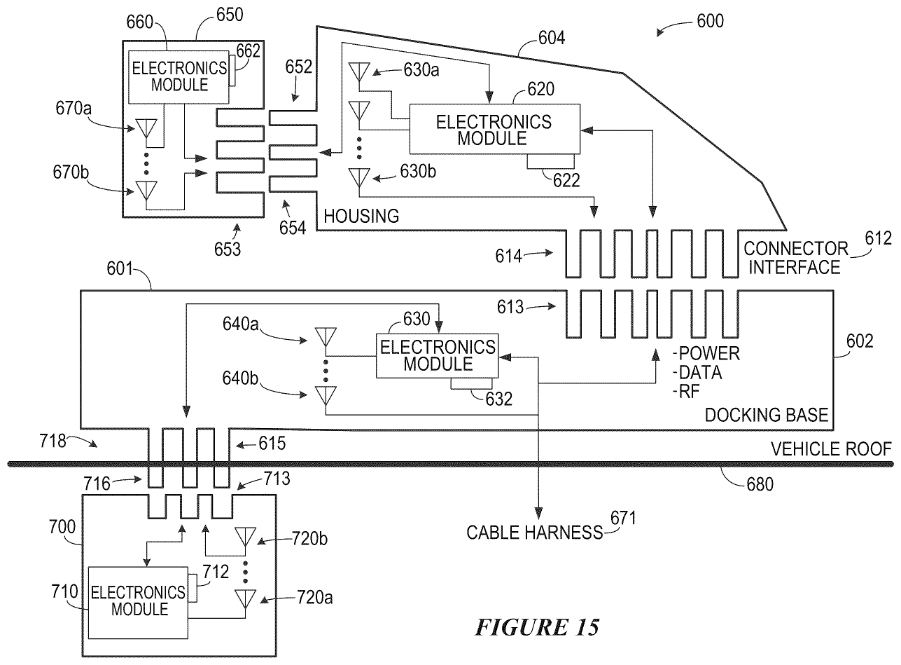

FIG. 15 illustrates a docking system in accordance with various embodiments. The docking system 600 shown in FIG. 15 includes the structures and components of the docking system 500 shown in FIG. 14 and includes additional features. The docking system 600 includes a dock 601 which comprises a base 602 configured to be affixed to a surface (e.g., a roof) of a vehicle. The docking system 600 also includes a housing 604, which contains various electronics and components, and a connector interface 612, which provides electrical coupling (e.g., power, data, RF) between the base 602 and the housing 604. The base 602 includes a first connector interface 613 and the housing 604 includes a second connector interface 614, the combination of which defines the connector interface 612.

The housing 604 contains an electronics module 620 coupled to one or more antennas 630a, such as any of the antennas listed above. The electronics module 620 can include, or be coupled to, one or more sensors 622, such as any of the sensors listed above. The electronics module 620 can include a multilayer motherboard populated with a number of components including passive and active components, surface mounted components, power modules, one or more controllers and/or processors, connectors, and ports, among other components. The electronics module 620 is communicatively coupled to the second connector interface 614 of the housing 604. In some implementations, one or more antennas 630b can be coupled to the second connector interface 614. The electronics module 620 and the one or more antennas 630b can be communicatively coupled to a cable harness 671 via the connector interface 612.

The base 602 includes an additional electronics module 630. The electronics module 630 can include a multilayer motherboard populated with a number of components including passive and active components, surface mounted components, power modules, one or more controllers and/or processors, connectors, and ports, among other components. The electronics module 630 can be coupled to one or more antennas 640a, such as any of the antennas listed above. The electronics module 630 can include, or be coupled to, one or more sensors 632, such as any of the sensors listed above. The electronics module 630 is communicatively coupled to the cable harness 671. In various implementations, one or more antennas 640b of the base 602 can be coupled to the cable harness 617. In some implementations, the electronics module 630 of the base 602 can be communicatively coupled to the electronics module 620 of the housing 604 via the connector interface 612.

The docking system 600 includes an additional module 650 configured to couple to the housing 604 and housing electronics 620 via a connector interface 652. The connector interface 652 comprises a third connector interface 653 of the additional module 650 and a fourth connector interface 654 of the housing 604. The third connector interface 653 comprises electrical connectors configured to detachably connect to corresponding electrical connectors of the fourth connector interface 654.

The additional module 650 includes an electronics module 660 which can be coupled to one or more antennas 670a, such as any of the antennas listed above. The electronics module 660 can include, or be coupled to, one or more sensors 662, such as any of the sensors listed above. The electronics module 660 can include a multilayer motherboard populated with a number of components including passive and active components, surface mounted components, power modules, one or more controllers and/or processors, connectors, and ports, among other components. The electronics module 660 is communicatively coupled to the housing electronics 620 via the connector interface 652. The additional module 650 can include one or more antennas 670b which can be coupled to the housing electronics 620 via the connector interface 652 or to the cable harness 671 via the connector interface 612. In some implementations, the electronics module 630 of the base 602 can be communicatively coupled to the electronics module 660 of the additional module 650 via the connector interfaces 612 and 652.

The embodiment of the docking system 600 shown in FIG. 15 includes an interior module 700 configured for use within an interior of the vehicle. The interior module 700 is configured to electrically couple to the base 602 and base electronics 630 via a connector interface 716. The connector interface 716 comprises a fifth connector interface 713 of the interior module 700 and a sixth connector interface 615 of the base 602. The fifth connector interface 713 can comprise electrical connectors configured to detachably connect to corresponding electrical connectors of the sixth connector interface 615. The connector interface 716 can include SMP connectors (e.g., snap-on or push-on SMP connectors) or SMA connectors for coupling RF conductors.

The interior module 700 is configured to mechanically couple to the base 602 via a coupling arrangement 718, which can incorporate the connector interface 716. For example, the interior module 700 and the base 602 can be mechanically connected via the coupling arrangement 718 which passes through the vehicle roof 680. In some implementations, the coupling arrangement 718 comprises a snap-on fastening arrangement or an interference fit arrangement (e.g., a press fit or friction fit arrangement). For example, the coupling arrangement 718 can include a number of corresponding male and female members that can be forced together (through the roof 680) to facilitate a snap-on or interference fit connection. Other coupling arrangements are contemplated, including arrangements that include bolts, screws, and/or other fasteners.

The interior module 700 includes an electronics module 710 which can be coupled to one or more antennas 720a, such as any of the antennas listed above. The electronics module 710 can include, or be coupled to, one or more sensors 712, such as any of the sensors listed above. The electronics module 710 can include a multilayer motherboard populated with a number of components including passive and active components, surface mounted components, power modules, one or more controllers and/or processors, connectors, and ports, among other components. The electronics module 710 is communicatively coupled to the base electronics module 630 via the connector interface 716. The interior module 700 can include one or more antennas 720b which can be coupled to the base electronics module 630 via the connector interface 716 or to the cable harness 671. In some implementations, the electronics module 710 of the interior module 700 can be communicatively coupled to the electronics module 620 of the housing 604 via the connector interfaces 716 and 612. In some implementations, the electronics module 710 of the interior module 700 can be communicatively coupled to the electronics module 660 of the additional module 650 via the connector interfaces 716, 612 and 652.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed embodiments may be practiced other than as explicitly described herein. For example, a docking system may be installed on a surface of a vehicle other than the vehicle's roof (e.g., on the trunk).

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or 10 more items in the list.

What is claimed is:

1. A system for a vehicle, comprising:
a dock comprising:
a base configured for attachment to a roof of the vehicle, the base comprising a recess and a conduit for accessing an interior of the vehicle; and
a first connector interface comprising a plurality of first electrical connectors configured to couple to respective electrical conductors arranged to pass through the conduit and into an interior of the vehicle; and
a housing configured to detachably connect to the dock, the housing dimensioned to be received by the recess of the base and comprising:
a first electronics module coupled to one or more first antennas; and
a second connector interface comprising a plurality of second electrical connectors configured to detachably connect to the first electrical connectors.

2. The system according to claim 1, comprising an attachment arrangement configured to slidably attach the housing to the dock.

3. The system according to claim 1, comprising an attachment arrangement configured to rotatably attach the housing to the dock.

4. The system according to claim 1, comprising an attachment arrangement configured to attach the housing to the dock, wherein the attachment arrangement comprises:
a cam lever disposed at a first wall of the base and configured to engage a cam interface situated at a rear surface of the housing; and
a guide slot at a front surface of the housing opposing the rear surface, the guide slot configured to receive a lip extending from a second wall of the base opposing the first wall.

5. The system according to claim 4, wherein actuation of the cam lever relative to the cam interface causes the guide slot to engage the lip of the base.

6. The system according to claim 4, wherein the attachment arrangement comprises an eject spring disposed on the second wall of the base opposing the first wall.

7. The system according to claim 1, comprising an attachment arrangement configured to slidably or rotatably attach the housing to the dock, wherein the attachment arrangement is configured to cause the first connector interface to matingly engage the second connector interface.

8. The system according to claim 1, wherein the first and second electrical connectors comprise power, data, and radio frequency (RF) connectors.

9. The system according to claim 1, wherein the base is configured to serve as a heatsink for the first electronics module of the housing.

10. The system according to claim 1, wherein the housing comprises a heatsink.

11. The system according to claim 1, wherein:
the base comprises a second module interface configured to receive and electrically couple to a second additional module via a coupling arrangement passing through the roof; and
the second additional module is situated in the interior of the vehicle proximate the base and comprises a second electronics module and one or more second antennas.

12. The system according to claim 1, wherein the housing comprises a third module interface configured to receive and electrically couple to a third additional module comprising a third electronics module and one or more third antennas.

13. The system according to claim 1, wherein the base comprises a fourth electronics module coupled to one or more fourth antennas.

14. The system according to claim 1, comprising one or more sensors.

15. The system of claim 14, wherein the one or more sensors comprise one or more of an accelerometer, a gyroscope, a temperature sensor, a camera, a radar sensor, and a lidar sensor.

16. The system according to claim 1, wherein the one or more antennas comprise one or more cellular, Wi-Fi, GPS, and satellite communication antennas.

17. A system for a vehicle, comprising:
a dock comprising:
a base configured for attachment to a roof of the vehicle, the base comprising a recess and a conduit for accessing an interior of the vehicle; and
a first connector interface comprising a plurality of first electrical connectors configured to couple to respective electrical conductors arranged to pass through the conduit and into the interior of the vehicle;
a housing configured to detachably connect to the dock, the housing dimensioned to be received by the recess of the base and comprising:
a first electronics module coupled to one or more first antennas; and
a second connector interface comprising a plurality of second electrical connectors configured to detachably connect to the first electrical connectors; and
a second module interface supported by the base and configured to receive and electrically couple to a second additional module via a coupling arrangement passing through the roof;
wherein the second additional module is situated in the interior of the vehicle and comprises a second electronics module and one or more second antennas.

18. The system according to claim 17, wherein the coupling arrangement comprises a snap-on fastening arrangement.

19. The system according to claim 17, comprising an attachment arrangement configured to slidably attach the housing to the dock.

20. The system according to claim 17, comprising an attachment arrangement configured to rotatably attach the housing to the dock.

21. The system according to claim 17, comprising an attachment arrangement configured to slidably or rotatably attach the housing to the dock, wherein the attachment arrangement is configured to cause the first connector interface to matingly engage the second connector interface.

22. The system according to claim 17, wherein the first and second electrical connectors comprise power, data, and radio frequency (RF) connectors.

23. The system according to claim 17, wherein the base is configured to serve as a heatsink for the first electronics module of the housing.

24. The system according to claim 17, wherein the housing comprises a heatsink.

25. The system according to claim 17, wherein the housing comprises a third module interface configured to receive and electrically couple to a third additional module comprising a third electronics module and one or more third antennas.

26. The system according to claim 17, wherein the base comprises a fourth electronics module coupled to one or more fourth antennas.

27. The system according to claim 17, comprising one or more sensors.

28. The system according to claim 27, wherein the one or more sensors comprise one or more of an accelerometer, a gyroscope, a temperature sensor, a camera, a radar sensor, and a lidar sensor.

29. The system according to claim 17, wherein in the one or more antennas comprise one or more cellular, Wi-Fi, GPS, and satellite communication antennas.
